(19) United States
(12) Patent Application Publication
(10) Pub. No.: US 2024/0050945 A1
(43) Pub. Date: Feb. 15, 2024

(54) SMOOTH FLOW CONTROL SYSTEMS FOR EMBEDDED MICROPUMPS ON MICROFLUIDIC CELL CULTURE DEVICES

(71) Applicant: Massachusetts Institute of Technology, Cambridge, MA (US)

(72) Inventors: Allison Lenhard, Torrance, CA (US); David L. Trumper, Plaistow, NH (US); Linda G Griffith, Cambridge, MA (US)

(21) Appl. No.: 18/446,947

(22) Filed: Aug. 9, 2023

Related U.S. Application Data
(60) Provisional application No. 63/396,526, filed on Aug. 9, 2022.

(51) Int. Cl. B01L 3/00

(52) U.S. Cl. CPC B01L 3/502746; B01L 2400/082; B01L 2400/0487; B01L 2300/069; B01L 2300/0654; B01L 2300/0874

(57) ABSTRACT

A flow control system that produces smooth flow for on-chip pneumatic micropumps has been developed. By establishing a flow control system that can achieve smooth flow, fluidic conditions of microphysiological systems can be controlled to accurately mimic biological conditions. Biological experiments can require flow profiles anywhere on the spectrum of smooth flow to highly pulsatile flow. A smooth flow profile can be modified with pumping delays to make the flow profile as pulsatile as desired.

### CROSS-REFERENCE TO RELATED APPLICATIONS

This application claims benefit of and priority to U.S. Application No. 63/396,526, filed Aug. 9, 2022, which is incorporated herein by reference in its entirety.

### STATEMENT REGARDING FEDERALLY SPONSORED RESEARCH

This invention was made with government support under EB029132 awarded by the National Institutes of Health. The government has certain rights in the invention.

### FIELD OF THE INVENTION

This is generally in the field of microfluidic pumps, and more specifically a continuous flow micropump and system for determining flow rate thereof.

### BACKGROUND OF THE INVENTION

Advancements in cellular biology, microfabrication methods, and the field of microfluidics allow biologists to closely replicate in vitro environments on organ-on-a-chip devices. Tissues can be cultured in these platforms even under complex conditions, such as mechanical stimuli and hormone and drug treatments. Tissue culture can be performed due to the controlled fluidic conditions that are maintained on the platforms. Small microphysiological systems are often referred to as organ-on-a-chip devices. Unlike mouse models, organ-on-a-chip devices offer biologists a way to study human tissues in a controlled environment, which allows for researchers to learn human-specific information about the process they are studying.

Microphysiological systems are not limited to the study of individual tissues. Many systems are used to perform multi-organ system studies. Multi-organ system studies have to be conducted with accurate fluidic conditions and maintain relevant metabolic profiles for the functions of the human organs being studied to be properly matched. Results from studies done on microphysiological systems are translated to insights for pharmacological application. An example of a commercially available microphysiological system developed by Emulate. This platform is an advanced microphysiological system that has integrated flow control capabilities. The chips used in this platform are made of polydimethyl sulfone (PDMS) and contain scaffolds that can replicate mechanical stimuli seen in vivo.

To gain accurate insights from studies performed on microphysiological systems, the microfluidic platform needs to replicate the in vivo fluidic conditions, such as flow smoothness/pulsatility and shear stress conditions, as closely as possible. Improvements in microphysiological system technologies have pushed the field towards creating an environment that is capable of matching in vivo conditions. However, most work on matching the flow conditions of biological systems has gone towards providing accurate average flow rates and not actually matching the flow profile. The types of micropumps that are often used on organ-on-a-chip devices, are usually driven with highly pulsatile flow without regards to how pulsatile the flow should be. Little work to improve the flow stability of pneumatic micropumps to produce smooth flow profiles has been done in the past. The pneumatic micropumps are activated with pressure steps and produce high instantaneous flow as a result, since flow goes as the derivative of pressure.

Prior attempts at smoothing the flow of pneumatic micropumps was focused on developing a fluidic capacitor to be used with the pump. Using a fluidic capacitor with pneumatic micropumps allows for the filtering of flow pulses produced when the micropump is actuated, which results in smoother flow profiles [S. W. Inman, “Development of a high throughput 3D perfused liver tissue bioreactor,” Thesis, Massachusetts Institute of Technology, 2006, accepted: 2007 January-10T16:59:50Z.]. An organ-on-a-chip designed in the Kamm lab at MIT also relies on a fluid capacitor to help stabilize fluid flow [Offeddu, et al, “Microheart: A microfluidic pump for functional vascular culture in microphysiological systems,” J. Biomechanics 119:110330 (2021)]. Others have also validated that compliant membranes can be integrated in fluid circuits to assist in the damping of fluid flow [B. Yang and Q. Lin, “A Compliance-Based Microflow Stabilizer,” Journal of Microelectromechanical Systems, vol. 18, no. 3, pp. 539-546, June 2009]. The flow control system that was used by Griffith is referred to herein as the standard flow control system. The standard flow control system hardware is split into two components, the pneumatic unit and the controller box. The standard flow control system was developed based on the two valve and one chamber pump design. The controller box used to control the pneumatics contains a disassembled National Instruments myRIO-1900 that has been placed in an alternative housing unit. The controller box is run through an interface designed by Continuum to control the solenoid outputs of the pneumatic unit. The pneumatic unit has 36 solenoid outputs; since three solenoid outputs are needed per pump, each pneumatic unit can be used to control twelve pumps. The system relies on accurate timing to actuate solenoids at the correct time intervals. There are three timing distribution options in the software.

The flow profile generated using the standard flow control system results in large flow spikes separated by long no-flow periods. For example, the period of one pump stroke at the high flow rate of 30 μL/min is 2 seconds, and over 75% of that period is spent under no-flow conditions. While pulsatile flow is sometimes desired to mimic various biological conditions, there are also applications where a smoother flow is necessary. Therefore, it is necessary to create a system where smooth flow can be achieved. By smoothing out the flow spikes that result from pumping with the standard flow control system, the pumps can be controlled to have a smooth flow profile.

Achieving both highly pulsatile and smooth flow profiles makes it possible to achieve any flow profile in that range. On that spectrum, the most difficult to achieve flow profile is smooth flow. Moving from pulsatile to smooth flow, the flow spike would be replaced by a smoothed period of continuous flow, and the opening and closing of the outlet valve would remain as these valves are still driven by pressure steps. The spikes in flow from opening and closing the valve are unavoidable due to the nature of the micropump. If a smooth flow profile is achieved, it is possible to add in delays to make the flow profile as pulsatile as desired. This would unlock the ability of the user to select a percentage of no flow desired for each pump stroke. The biologist could tailor the flow based on the biological experiment being performed, which would help ensure the experiment is run to best mimic in vivo conditions.

If a smooth flow profile could be achieved, it would be possible to add in delays to make the flow profile as pulsatile as desired. This would unlock the ability of the user to select a percentage of no flow desired for each pump stroke. The biologist could tailor the flow based on the biological experiment being performed, which would help ensure the experiment is run to best mimic in vivo conditions.

It is therefore an object of the present invention to provide a continuous flow pump for use with microfluidic systems.

It is a further object of the present invention to provide a system reproducing physiological conditions and processes as accurately as possible, to generate the same flow profiles found in vitro.

It is another object of the present invention to find an inexpensive, efficient, easy and spacing saving way to monitor flow rate of a micropump in a microfluidics system.

### SUMMARY OF THE INVENTION

A flow control system that produces smooth flow for on-chip pneumatic micropumps has been developed. By establishing a flow control system that can achieve smooth flow, fluidic conditions of microphysiological systems can be controlled to accurately mimic biological conditions. Biological experiments can require flow profiles anywhere on the spectrum of smooth flow to highly pulsatile flow. A smooth flow profile can be modified with pumping delays to make the flow profile as pulsatile as desired.

Three flow control system approaches for smooth flow that can achieve smooth flow profiles at flow rates up to 1 μL/s were tested. Two different iterative learning control (ILC) algorithms relying on either direct or indirect sensing methods were developed to allow for feedback driven flow control systems. A packaged open-loop flow control platform was also developed and is less complex than its ILC driven counterparts and can be used without modifying the chips since sensing is not necessary. These systems all perform consistently and maintain accurate flow rates while producing smooth flow profiles. These smooth flow control systems for embedded micropumps on microfluidic cell culture devices include open-loop pressure waves for smooth flow, displacement/flow sensing using an optical sensor, and methods for coating the membranes of the devices for sensing purposes. The micropumps are pneumatically actuated and the control system used to create a smooth flow profile by gradually actuating the pump chamber with an electronic pressure regulator. The control systems include an iterative learning control algorithm that relies on either flow sensor or optical sensor feedback to modify a pressure control signal to actuate the pump chamber and an open-loop system that uses specified pressure signals that correspond to a variety of flow rates.

In order to use optical sensors with the microfluidic devices, the embedded micropump pump chamber is coated so it becomes a reflective surface. This was developed along with a way to coat the chamber with toner transfer foil specifically, but other coatings such as an aluminum coating could be applied in a similar manner. The coating enables the use of an optical sensor for chamber displacement/flow rate monitoring/control. The optical sensor can also be used as a pressure sensing method.

Existing flow control systems do not provide smooth flow. They are typically built with pneumatic solenoids, which only allow for a step in pressure on the pump chamber. The pressure step applied to the chamber results in pulsatile flow. While pulsatile flow is desired in some biological applications, smooth flow is desired in others. The smooth flow control systems described herein allow for biological studies having the smooth flow profiles found in vivo. Microfluidic cell culture devices that offer integrated on-chip pumping capabilities are not usually run with any flow sensing capabilities. This is because these devices are designed to be disposable and integrating a sensor on chips that will be thrown away is costly. The optical sensing method described herein allows for flow sensing without the need for an integrated sensor. The optical sensor remains completely separate from the chip and is able to provide flow feedback based on the deflection of the coated pump chamber membrane. The coating method does not result in contamination and the only change necessary to the chip is applying the coating to the membrane before the chip is fully assembled.

### BRIEF DESCRIPTION OF THE DRAWINGS

FIGS. 1A and 1B are hand drawn graphs of the flow profiles with the standard flow control system (1A) and the continuous flow system (1B).

FIGS. 2A-2C are prospective views of a chip with integrated tubing connections was designed. FIG. 2A shows the fluidic side; FIG. 2B shows the assembled chip with optical film, and FIG. 2C shows the pneumatic side. These show the independent pneumatic connections of the two pumps and the locations meant for attaching the tubing connection interface components. The fully assembled chip, interfaced to the Sensirion LPG10, is shown in FIG. 2D. A schematic of the whole flow control system with extra pneumatic and electrical hardware is shown in FIG. 2E.

FIG. 3A is a graph of time versus flow rate, showing the flow rate set point curve has a period of T, where T is determined based on the flow rate input. For example, the total period of the pump stoke, Tₜₒₜₐₗ, would be 2 seconds for a flow rate input of 0.5 μL/s, since 1 μL/s is dispensed each pump stroke. T is then determined by subtracting the time needed to actuate the valves, t, from Tₜₒₜₐₗ. The set point curve can be divided into two parts: a ramp up from a flow rate of 0 to the flow rate that brings the integral of the flow rate set point curve to 1 μL and a constant function at the ramp's ending flow rate. The ramp portion of the curve has a period of 0.1 T. FIG. 3B is a cross-sectional view of a simplified mechanical model of the micropump. The micropump was approximated as a frictionless and massless cylindrical piston supported by a spring. The piston is the fluidic seal and the spring is the stiffness of the diaphragm.

FIGS. 4A-4C are schematics of devices for detecting pump displacement. FIG. 4A shows the use of a laser and photodetector, with reflective marking; FIG. 4B shows a camera and mark on the pump chamber membrane that is monitored; FIG. 4C shows an optical sensor to monitor the displacement of the membrane by sensing the movement of a coating to reflect the light emitted from the optical sensor. FIGS. 4D-4F are cross-sectional diagrams of an optical sensor package containing both an infrared (IR) light emitting diode (LED) (FIG. 4D) and a phototransistor (FIG. 4E). FIG. 4F shows them in abutment to monitor displacement, wherein the phototransistor collector-emitter current is dependent on the amount of IR light reflected back onto the phototransistor from the surface illuminated by the LED.

FIGS. 5A-5C are graphs of measured flow rate (μl/min) (FIG. 5A), applied pressure (psi) (FIG. 5B) and optical sensor voltage (V) output (FIG. 5C) over time (seconds).

### DETAILED DESCRIPTION OF THE INVENTION

### I. Definitions

According to the NTP Interagency Center for the Evaluation of Alternative Toxicological Methods, a microphysiological system is “an in vitro platform composed of cells; explants derived from tissues/organs; and/or organoid cell formations of human or animal origin in a micro-environment that provides and supports biochemical/electrical/mechanical responses to model a set of specific properties that define organ or tissue function”,

Microfluidics: the field of microfluidics refers to both the behavior and control of fluids that are constrained in small scale systems with volumes on the order of uLs or smaller

As used herein a “chip” or “organ-on-a chip” refers to a microfluidic device containing embedded cells and/or tissues that is used to simulate physiological systems outside of a living organism.

“In vitro” refers to studies performed outside of a living organism.

“In vivo” refers to studies performed within a living organism. Flow rates between 0-1 μL/s are necessary to match in vivo conditions

### II. Pump

### Flow Control System Design

The standard pump control systems are isolated into two units, a unit containing the controller hardware and a unit housing pneumatic and corresponding electronic hardware. The pump control systems actuate each micropump by switching three pneumatic solenoids between pressure and vacuum in a sequence dependent on the current pump state. These states determine if the inlet valve, outlet valve, and pump chamber needs to driven by a pressure or vacuum signal.

### Pumping States

Preferred pneumatic micropumps designed by O'Boyle [D. A. O'Boyle, “Integrated Disposable Microfluidic Tissue Chips,” Thesis, Massachusetts Institute of Technology, June 2021, accepted: 2022 January-14T15:06:43Z.]. These micropumps consist of a pump chamber between two valves. The pump chamber is designed to dispense one microliter of fluid per pump stroke. This fixed volume allows for deterministic flow rates depending on how often a pump stroke occurs. Prior art micropumps use a configuration of the pump chamber and valves divided into states. For example, Inman categorizes the pumping sequence of this type of micropump into six states [Inman, “Integration of real time oxygen measurements with a 3D perfused tissue culture system,” Thesis, Massachusetts Institute of Technology, 2011, accepted: 2011 December-09T21:28: 12Z.] .

Based on the pump design, the closed position of a valve or the pump chamber occurs when the applied pneumatic signal is positive air pressure. Conversely, applying negative air pressure to the membrane opens the valve or pump chamber, which allows fluid to flow into the corresponding pump element. The pneumatic layer of the chip is below the fluidic layer, meaning the membrane pushes against the upper fluidic layer when closed or the lower pneumatic layer when open.

For the pump control applications, the starting state, state 1, of the pump is considered to be when both the inlet and outlet valve, as well as the pump chamber, are all in the closed position. The transition to state 2 occurs when the inlet valve is opened by applying negative air pressure to pull back the membrane so it no longer seals along the valve seat. Once the inlet valve is fully opened, the pump chamber is opened to proceed to state 3. The aspiration of the pump chamber while the inlet valve remains open allows fluid to fill the volume of the pump chamber. When aspiration is complete, positive air pressure is applied to the inlet valve to create a seal between the membrane and the valve seat to ensure no fluid contained in the pump chamber can backflow. The closing of the inlet valve marks the move to state 4. Before the fluid can be dispensed from the pump chamber, the outlet valve must be opened. Therefore, the transition to state 5 occurs when negative air pressure is applied to the outlet valve. To get to state 6, all the fluid is then dispensed from the pump chamber when the applied air pressure on the pump chamber is switched from negative to positive pressure. Finally, the pump is brought back to state 1 when the outlet valve is closed, completing the pump stroke.

The flow of interest is considered to be the flow that occurs between the outlet valve and the back pressure regulator on the chip. Therefore, the goal of the flow control system is to smooth out the flow occurring during the dispensing stage. However, similar methods could be applied to the aspiration stage to achieve smooth flow on the aspiration side of the fluid circuit as well if that is desirable. When considering the fluid circuit after the outlet valve, spikes of flow during the pump stroke are unavoidable when the outlet valve opens and closes, unless we also control the valve pneumatic signal. The valves are designed to have a volume of 0.188 μL, which is nearly an order of magnitude smaller than the pump chamber volume of approximately 1 μL. Because of the small volume of the valves, the spikes in flow caused by opening and closing the valve are less significant. When attempting to improve flow stability, these spikes will not be considered as an area of flow to be smoothed over in the present effort. However, the techniques shown here can be readily applied to the valves by using contoured pressure signals to actuate the valve diaphragms in a manner similar to the pump chamber.

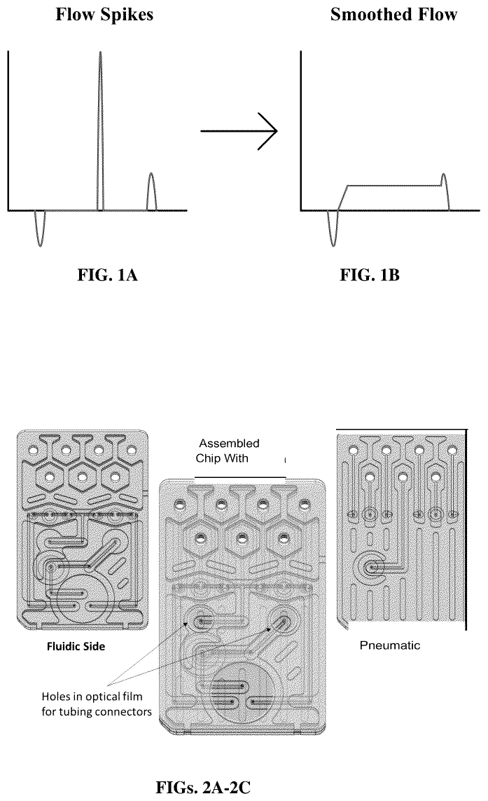

To stabilize the flow when the fluid in the pump chamber is dispensed, the fluid needs to be dispensed over the cycle time at an approximately fixed rate. Since the prior standard pump control system relies on a solenoid to rapidly switch from negative to positive air pressure on the pump chamber, the full volume of fluid is dispensed quickly at a high instantaneous flow rate. This results in a short period of high flow and a much longer period of no flow, as seen in FIG. 1A. In order to improve the flow stability performance of the pump, a gradual change in pressure should be applied to the pump chamber as opposed to switching from negative to positive pressure instantaneously. This gradual change in pressure allows for continuous flow during the dispensing stage rather than an impulse of flow followed by zero flow. Furthermore, by minimizing the time spent in the five states prior to draining the pump chamber it is possible to extend the time spent with continuous flow.

Just as the standard pump control system is composed of pneumatic and control hardware, the new flow control platform requires the integration of these two systems. However, in order to transition from a flow control system that only relies on solenoids, which switch pressure in a step, to one that is capable of a gradual change in pressure, it is necessary to adapt new hardware. One of the most significant changes is incorporating an electronically variable pressure regulator to allow for a controllable pressure signal on the pump chamber diaphragm. This produces the flow pattern shown in FIG. 1B.

### Incorporating an Electronic Pressure Regulator

Switching from a solenoid to an electronic pressure regulator to apply the pneumatic signal onto the pump chamber element of the pump changes the pressure signal from a step function to any specified function of time. Tailored pressure signals are possible due to the nature of electronic pressure regulators. These regulators are usually provided with either a current or voltage input that is the set point for a proportional pressure output. Electronic pressure regulators rely on the feedback provided by a pressure sensor monitoring the regulator's output pneumatic pressure. The electronic pressure regulator has an internal PID controller that utilizes this pressure feedback to provide a precise output pressure by continuously adjusting internal valve positions [B. Lee, “Electronic pressure regulator,” in 26th Joint Propulsion Conference. Orlando, FL, U.S.A.: American Institute of Aeronautics and Astronautics, July 1990.] The user can adjust the regulator's PID controller to improve the regulator's ability to follow the desired input signal.

Two different electronic pressure regulators were considered when constructing the pump control system. The main two requirements used to select electronic pressure regulator candidates were an operating gauge pressure range of vacuum (≈−1 bar to approximately +1 bar), and a relatively fast response time. The first regulator of interest was the Clippard Cordis pressure control unit [Clippard, “Cordis High Resolution Electronic Proportional Pressure Controls,” Cordis Datasheet]. The Cordis unit can be customized for operating pressure ranges anywhere between vacuum and 150 psig and offers a typical response time of less than 20 ms. In addition to meeting the main requirements, the Cordis unit stood out due to its customizability, integrated sensor, compact size, and relatively low cost.

The other regulator that was considered is the Enfield TR-010-v-ex electronic pressure regulator [Enfield Technologies, “TR Electronic Pressure Regulators,” TR Electronic Pres-sure Regulator Datasheet.]. Like the Cordis unit, the Enfield TR regulator meets the main two requirements regarding operating pressures and speed. In fact, the Enfield TR regulator is relatively fast, with a response time of 2.5 ms. However, the Enfield TR regulator is significantly bulkier than the Cordis unit and costs nearly twice as much as the Cordis unit. After acquiring both electronic pressure regulators, they were both tested to see which regulator could better follow a designated input signal designed to mimic a simplified version of the afore-mentioned pump states. Since the aspiration stage of the pumping sequence is meant to occur as quickly as possible, the input signal requires a relatively fast step down from positive pressure to vacuum. The Cordis unit is unable to achieve this pressure change quickly. Since the Enfield TR regulator is capable of rapidly changing from positive to negative air pressure, it was selected as the flow control system's electronic pressure regulator. It is worth noting that if gradual aspiration and dispensing were desired for the pumping sequence, the Cordis unit's performance would be adequate and could be used to control the pump chamber pressure signal.

### Solenoids for Valve Actuation

While it is necessary to actuate the pump chamber with a gradual pressure signal, in this work the valves of the pneumatic micropump are still actuated with a rapid change between positive and negative air pressure. This allows a simpler configuration in which the same solenoids used in the standard pump control platform are used to actuate the valves in the continuous flow control system. These solenoids are 3 port solenoid valves, SMC S070B-6CG SMC, “3 Port Solenoid Valve Series S070,” Series S070 Datasheet, 2019]. These solenoids have a coil voltage of 12 VDC and a power consumption of 0.5 W. Proper electrical components will be selected based on these specifications.

Each solenoid is to be switched on using a digital output signal of 3.3 V. To turn the solenoid on or off a transistor is used as a switch. To achieve this a transistor, resistor, and flyback diode are needed for each solenoid. The flyback diode allows current to only pass in one direction, therefore preventing potential damage to the solenoid that would be caused by the flyback voltage spike. A KSP2222A transistor [Fairchild Semiconductor, “KSP2222A NPN General Purpose Amplifier,” KSP2222A Datasheet, 2006] was chosen as a suitable transistor to use as a switch for the solenoids based on its maximum collector current and current gain. With this transistor in mind, a base resistor with a resistance of 1.7 kΩ was selected to achieve a high enough base current to properly saturate the transistor as a switch. The flyback diode selected was a power blocking diode, 1N4001. This diode can protect against a reverse voltage of 50 V and pass 1 A current continuously , [______, “1N4001-1N4007—General-Purpose Rectifiers,” 1N4001-1N4007 Datasheet, 2014], which exceeds the necessary requirements for this application.

Two solenoids are necessary per micropump to individually control the inlet and outlet valve. For standardization purposes, the pneumatic ports in the solenoid array base mount are connected to positive pressure and vacuum sources, such that when the solenoid is in the off position the output is negative pressure. This ensures that when the system is off the valves of the micropump are in the open position.

### Flow Sensor

A sensor is required for the flow control system to achieve stable flow rates when actuating the pneumatic micropumps with feedback control. When initially implementing a control scheme, an onboard sensing method was used to directly measure the flow rate of the fluid exiting the outlet of the micropump. Once a control scheme with adequate performance was achieved with direct onboard flow rate sensing, the possibility of feedback control using an indirect sensing method was explored.

The sensor selected to use for feedback control is the Sensirion LPG10-1000 Liquid Flow Sensor [Sensirion, “LPG10-1000 Liquid Flow Sensor,” LPG10-1000 Datasheet, 2019]. The Sensirion LPG10 is a thermal mass flow meter, which means that by using a heating element between two temperature sensors the flow can be determined based on the temperature change of the fluid [Kim, et al. “Study of the sensitivity of a thermal flow sensor,” Int. J. Heat Mass Transfer, 52(7), 2140-2144 (2009)]. Digital communication with the Sensirion LPG10 is through a standard I2C-interface [ Sensirion, “LPG10-1000 Liquid Flow Sensor,” LPG10-1000 Datasheet, 2019]. The flow data was collected using a Sensirion LPG10 flow sensor while the micropump was run at a flow rate of approximately 0.2 μL/s. The flow data was collected for three pump strokes and was measured after the outlet valve of the micropump. The large spikes in flow, peaking at 1500 μL/min, occur when the fluid is dispensed from the pump chamber. The small spikes in flow, peaking at about 100 μL/min, occur when the outlet valve is opened and closed. When the outlet valve is opened, fluid is pulled in causing a negative spike in flow, and when the outlet valve is closed, fluid is propelled out of the valve causing a positive spike in flow.

### NI Hardware

Similarly to the standard pump control platform, the pump control system is implemented on an NI myRIO. The NI myRIO-1900 is a re-configurable input/output (I/O) device that can be used for real-time applications [National Instruments, “National Instruments User Guide and Specifications: NI myRIO-1900,” NI myRIO-1900 Manual, 2016]. The myRIO is used to implement a real-time controller to control the flow of the pumps. The myRIO has analog and digital I/O as well as I2C channels. Analog I/O capabilities are necessary for controlling and monitoring the pressure signal of the electronic pressure regulator. Digital outputs are needed to switch the solenoids on and off to control the valves. I²C capabilities make it possible to directly interface with the Sensirion LPG10 flow sensor.

Since the Enfield TR regulator is commanded with a 0-10V input signal, the myRIO MSP connector C was utilized as the analog output has a ±10 V range. However, the I²C channels on the myRIO are located on the A and B MXP connectors. Therefore, both the MSP and one MXP connector were used. While the myRIO was used for this thesis work, other NI hardware with the same capabilities could be used instead. The myRIO is programmed using LabVIEW, which also implements the user interface.

### Chip Design for Flow Monitoring

Without a way to monitor the flow rates produced by the micropumps on the microfluidic chips, the flow control system has no way of being implemented. The chip designs established in D. A. O'Boyle, “Integrated Disposable Microfluidic Tissue Chips,” Thesis, Massachusetts Institute of Technology, June 2021, accepted: 2022 January -14T15:06:43Z] do not have a way to easily interface with the Sensirion LPG10 flow sensor. Originally, an available EndoChip [D. A. O'Boyle, “Integrated Disposable Microfluidic Tissue Chips,” Thesis, Massachusetts Institute of Technology, June 2021, accepted: 2022 January -14T15:06:43Z] was modified to have flow connections. In order for these connections to work properly, the chip's onboard back pressure regulators were closed using a high positive pressure signal of approximately 15 psi. The modified EndoChip has a tube routing from the gel compartment of the chip to the Sensirion LPG10 and the out-put of the Sensirion LPG10 was connected to a collection tube. Due to the way the EndoChip was modified, leaks between the two channels surrounding the gel compartment would often occur. The leaks across the channels made it difficult to know if the pump chamber was dispensing the correct fluid volume on each pump stroke. Because of the issue of cross-channel leaking, the modified chip was only used for initial testing and validation purposes.

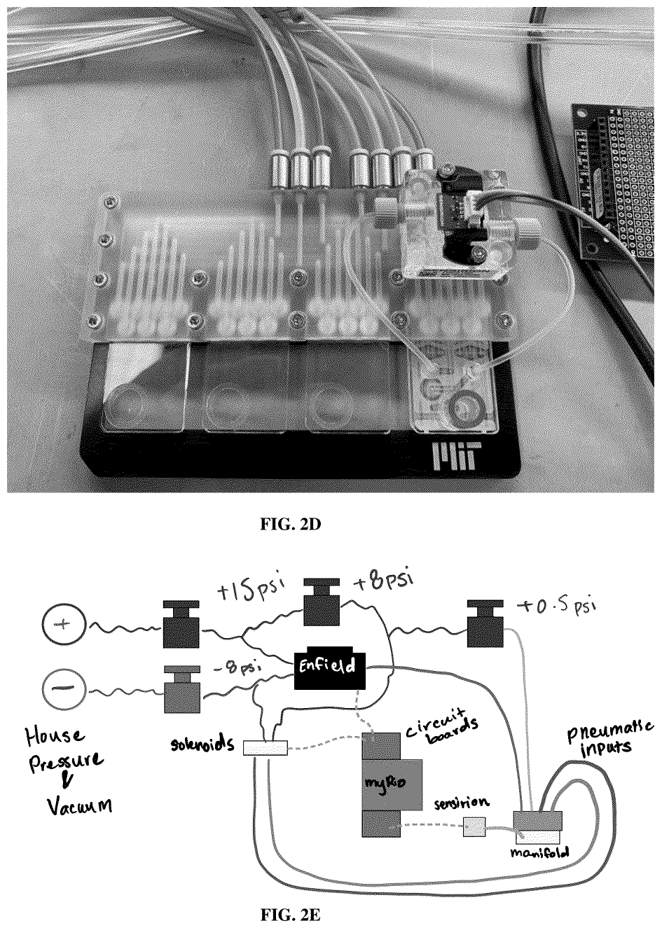

In order to have a proper platform to develop a flow control scheme, a chip with integrated tubing connections was designed. The chip was designed to have two independently controlled pumps to allow running one individual pump or both pumps simultaneously. The CAD drawing of the tubing connection chip, FIGS. 2A-2C, shows the independent pneumatic connections of the two pumps and the locations meant for gluing the tubing connection interface components. This chip was manufactured using the methods established by O'Boyle in his work [D. A. O'Boyle, “Integrated Disposable Microfluidic Tissue Chips,” Thesis, Massachusetts Institute of Technology, June 2021, accepted: 2022 January-14T15:06:43Z].

The purpose of the integrated tubing connection chip was to provide a well-made platform to monitor the flow of the pumps. To ensure the pump chamber and valve volumes were as accurate as possible and that the pump chambers and valves had smooth surfaces, plastic polish was used to smooth the pump chamber and valve surfaces. The fully assembled chip was interfaced to the Sensirion LPG10, FIG. 2D.

### Platform Integration

To integrate the whole flow control system, extra pneumatic hardware is necessary. The number of pressure regulators needed for the platform is dependent on the number of back pressure regulators on the microfluidic chip. For the integrated tubing connection chip there is only one onboard back pressure regulator, therefore three pressure regulators and one vacuum regulator are needed for the flow control system. For each additional on-chip back pressure regulator that is to be operated at a different pressure, an additional positive pressure regulator is needed.

One pressure regulator is used to regulate house pressure to approximately 15 psi. The 15 psi output is then used as the input for the electronic pressure regulator and as the input to a second pressure regulator. The second pressure regulator is used to regulate down to approximately 8 psi. The 8 psi output is used to control the positive pressure input to the solenoids. The third pressure regulator is used to regulate the pressure signal on the on-chip back pressure regulator. Since this pressure signal will be small, around 0.5 psi, the input to the regulator can be the 15 psi or 8 psi pressure line. Lastly, the vacuum regulator is used to prevent disturbances in the vacuum signal resulting from fluctuations in house vacuum. This regulator should be set to approximately −8 psi and the output is used to supply the negative pressure input to the electronic pressure regulator and the solenoids.

A schematic of all the necessary hardware as well as pneumatic and electrical connections is provided in FIG. 2E. The list of components needed for the flow control system are as follows:
Pressure regulators (three pressure regulators and one vacuum regulator)
Electronic pressure regulator
Solenoid array

The complete hardware setup for the novel flow control system.
Electronics board
NI myRIO
Flow sensor
Manifold containing chips

The flow control system can be made more compact with careful selection of small-footprint regulators and custom made circuit boards rather than breadboards.

### First Controller Design

Switching between the six states of the pump controller results in only part of the pump stroke sequence being controlled. In a pumping scheme where both gradual aspiration and dispensing are desired, only these two states need to be controlled. Only gradual dispense is needed and rapid aspiration is acceptable. However, the same control methods could be applied to the aspiration state to also achieve gradual aspiration. All controller programming was done using LabVIEW. The controller discussed below relies on flow rate feedback from the Sensirion LPG-10 flow sensor.

The initial controller design was based on a simplified model of the pump chamber. This controller was then modified to account for physical nuances of the system. The modified controller yielded promising flow profiles at low flow rates, but could not perform at higher flow rates that would be necessary for some experiments. This was due to the shortened control time period associated with the higher flow rates.

### Controller State Machine

To isolate the period of feedback control during a pump stroke, a state machine was constructed. Each state in the state machine has a set time duration, and the next state is entered once the time duration of the previous state is completed. All non-feedback dependent states were assigned predetermined pressure outputs corresponding to the valves and pump chamber. During the dispensing state, which is the period of feedback control, the valves are actuated in a predetermined manner (open or closed) while the pump chamber is actuated using feedback control. The min pressure is determined through user input, the max pressure is determined by the control signal bounds, and the control signal is determined by the controller.

TABLE 1
Values for States 1-6

| | Inlet | Pump | Outlet |
|---|---|---|---|
| State | Valve (psi) | Chamber (psi) | Valve (psi) |
| State 1 | +8 | max pressure | +8 |
| State 2 | −8 | max pressure | +8 |
| State 3 | −8 | min pressure | +8 |
| State 4 | +8 | min pressure | +8 |
| State 5 | +8 | min pressure | −8 |
| State 6 | +8 | control signal | −8 |

The controller state machine is the centerpiece of the LabVIEW code since it controls the pumping sequence. Outside of the state machine, a variety of tasks are continually being done for both monitoring and functional purposes. Other tasks are also performed outside the state machine, but only if certain front panel user inputs are changed while the code is running.

### LabVIEW Code Structure

In the exemplary form, the LabVIEW code is composed of both a front panel that acts as the user interface and the block diagram that contains the graphical source code of the program. The front panel design was kept simple with two graphs for monitoring purposes as well as a variety of user inputs to run the code in the desired manner.

On the left-hand side of the front panel there are three numerical input boxes for inputting the minimum and maximum pressures (psi) that should be permitted on the pump chamber and the desired flow rate in μL/s. Below these input boxes, there is an error indicator to display if any errors arise when running the code. Additionally, there is a stop button below the error display box so the user can stop the code from running. To the right, there are two graphs for monitoring flow and pressure data. The top graph plots the flow rate data coming from the Sensirion flow sensor connected to the chip as well as the flow rate set point curve. The bottom graph plots the pressure data from the electronic pressure regulator controlling the pressure signal on the pump chamber. Both the pressure being inputted by the controller algorithm and the pressure output determined by the regulator's sensor are plotted. To the right of the graph there is one input and two outputs associated with a volume totalizer. The input button controls whether or not the totalizer is turned on. Pushing the button to turn the totalizer off after it has been running resets the totalizer to zero. The totalizer keeps track of the total fluid dispensed since being turned on and uses this volume and the elapsed time since the button has been pushed to calculate the actual average flow rate.

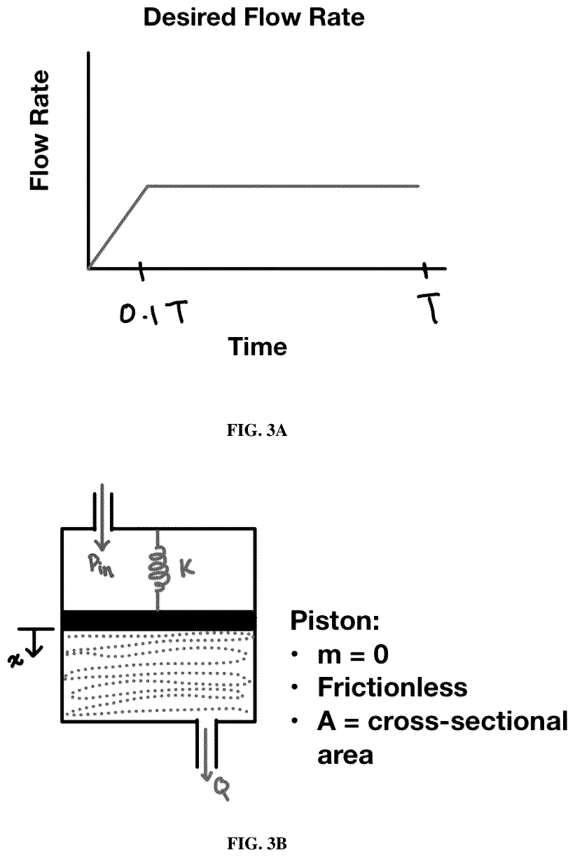

To achieve this front panel, most of the graphical front panel code is contained in a main loop. The main loop is run at 100 Hz and during a single run of the loop five main tasks are performed. The five tasks include checking for a change in the flow rate user input, reading the Sensirion flow rate measurement, updating the totalizer if the totalizer is turned on, sending digital/analog outputs based on the state machine, and monitoring the electronic pressure regulator's pressure input and output. If any change in the flow rate user input has occurred, the flow rate set point array is modified to reflect this change. The flow rate set point curve has a period of T, and T is determined based on the flow rate input. For example, the total period of the pump stoke, Tₜₒₜₐₗ, would be 2 seconds for a flow rate input is 0.5 μL/s, since 1 μL is dispensed each pump stroke. T is then determined by subtracting the time needed to actuate the valves, t, from Tₜₒₜₐₗ. The set point curve can be divided into two parts: a ramp up from a flow rate of 0 to the flow rate that brings the integral of the flow rate set point curve to 1 μL and a constant function at the ramp's ending flow rate. The ramp portion of the curve has a period of 0.1 T. An example of this set point curve can be seen in FIG. 3A. When a new reading is made from the Sensirion using the I2C-interface this reading is plotted on the flow monitoring graph and is used for the totalizer measurement if the totalizer is set to on. The totalizer is updated using the trapezoidal rule to estimate the integral of the flow graph to get the volume dispensed. Depending on the current state of the controller state machine the digital outputs for the two valves and the analog output for the pump chamber are either updated or kept the same. The digital outputs are used to switch two solenoids on and off to apply either positive or negative air pressure to the valves; however, the analog output is used to send a 0-10 V signal to the electronic pressure regulator to control the pressure output. 0 V corresponds to −14.5 psi while 10 V corresponds to +14.5 psi. Two analog inputs are also used to monitor the feedback signals from the electronic regulator which provides two 0-10 V signals corresponding to the pressure sensor measurement and the voltage being input to the regulator. These two inputs are plotted on the pressure graph.

A simplified mechanical model of the micropump was created to aid in the initial controller design. The micropump was approximated as a frictionless and massless cylindrical piston supported by a spring. The piston is the fluidic seal and the spring is the stiffness of the diaphragm. FIG. 3B contains a drawing of the model labeled with important variables. This model was used to determine the relationship between flow rate and change in applied pressure. Three equations are necessary to determine the relationship between the change in air pressure, dPᵢₙ/dt, and flow rate, Q. By balancing the forces from the input pressure and the spring we get the resulting equation:

PinA=kx

By relating displacement to volume and change in volume to flow rate we get Equation 4.2 and Equation 4.3.

The dispensed volume is

V=Ax,
with resulting flow rate

$$Q = \frac{dV}{dt} .$$

By plugging Equation 4.1 into Equation 4.2 we get dispensed volume as

$$V = \frac{{A}^{2}}{k} {P}_{m} .$$

Taking the derivative of Equation 4.4 and substituting Q for dV/dt based on Equation 4.3 gives the final equation:

$$Q = \frac{{A}^{2}}{k} \frac{{dP}_{m}}{dt} ,$$

The flow rate, Q, is proportional to the change in pressure over time, dPᵢₙ/dt. For the controller, the manipulated variable can easily be the input dt [symbol] pressure, Pin, or the change in pressure dPᵢₙ/dt. By using change in pressure rather than pressure itself as the manipulated variable, only a proportional controller is needed rather than an integral controller. If the input pressure was the manipulated variable, an integral controller would be necessary to account for the derivative term of the plant, since the flow rate, Q, is related to the rate of change in pressure, dPᵢₙ/dt, not pressure itself. The integral term becomes embedded in the controller if dPᵢₙ/dt is used as the manipulated variable, so the controller presents as a purely proportional controller. This keeps the controller as simple as possible for the initial controller design.

### Proportional Control

Based upon the simplified model, it was decided that a proportional controller would be implemented to control the dispense state. The controller is formatted such that the initial pressure signal is set as the minimum pressure input by the user, such that the pump chamber is pulled to maximum volume. The error of the measured flow when compared to the flow set point curve is multiplied by the proportional gain Kₚ. The product of the error and the gain is the change in pressure which is added to the previous input pressure and sent as the new command for the electronic pressure regulator. This process is done at 100 Hz and lasts the dispense period. This process is reset when a pump stroke is completed.

The proportional gain value was tuned using trial and error. Initially the value was reduced by an order of magnitude until the pressure signal stabilized. Once the pressure wave stabilized, small adjustments were made until performance peaked. Once the gain was selected, the controller was run for various flow rates to gauge controller performance.

### Initial Results

The controller is not run continuously even though pumping is run continuously. Instead, the controller is only on for the sixth state of the pump cycle, i.e., dispense. There is only a fixed amount of fluid, 1 μL, that can be dispensed during a pump stroke, meaning that fluctuations in the flow rate around the set point can result in fluid being dispensed too quickly resulting in an unreachable set point. Because the goal of the controller is to improve the smoothness of flow compared to the large spike generated by the standard flow control system, small fluctuations in flow around the set point are acceptable.

The controller was initially run at a flow rate of 0.2 μL/s to see the performance at a low flow rate. The large spikes in the flow profile are from opening and closing the outlet valve and are not part of the controlled profile. For simplicity, the flow rate set point curve is set as 0 for all states other than the dispense state and should be ignored. The measured flow rate stayed close to the flow rate set point curve with variations staying in the +/−4μL/min range. During the initial ramp up period, the measured flow rate lagged behind the set point curve. The measured average flow rate was about 96% of the desired flow rate (0.192 μL/s vs 0.2 μL/s). This is likely always be a discrepancy due to the machining and assembly process since it is difficult to get a micropump with an exact 1 μL chamber volume.

The controller was also run at a 0.33 μL/s flow rate. At this higher flow rate the measured flow rate was still able to stay close to the flow rate set point curve with variations staying in the +/−5 μL/min range. During the initial ramp up period, the measured flow rate did not lag as far behind the flow rate set point like it did when set to 0.2 μL/s. The measured average flow rate, 0.313 μL/s was 95% of the desired flow rate.

The performance of the proportional controller at both a 0.2 and 0.33 μL/s flow rate was better than anticipated. The proportional controller greatly smoothed the flow profile compared to the standard flow control system. However, there was some concern with the physical implications of the pressure signal profile.

### Modifying the Controller

While the performance of the proportional controller was promising, one concerning aspect of the controller performance is small blips in which the pressure input is set as decreasing. During a pump stroke, the pressure input should always be increasing so fluid is only dispensed from the chamber and not sucked back into the chamber. A negative change in pressure commands results when the flow rate error is negative, meaning the measured flow rate is higher than the desired flow rate. Spikes in the flow are unavoidable and are not an actual indicator that too high of a pressure change occurred. However, the controller response to these spikes results in negative changes in input pressure. To avoid negative changes in the pressure signal input, a heuristic control element was added to the controller.

The heuristic element that was added sets the change in pressure to 0 if the change in pressure is negative. Adding this heuristic results in a smooth pressure signal being applied to the pump chamber. Again, adding this heuristic makes physical sense because we only want fluid to be dispensed from the pump during the control period and a negative change in pressure draws fluid back into the pump chamber.

After adding the heuristic element to prevent backflow, the modified controller was tested again at various flow rates. The two main test flow rates used were again 0.2 and 0.33 μL/s. Higher flow rates including 0.4, 0.5, 0.75, and 1 μL/s also were used for testing the controller, but the spikes in flow become more significant at these higher flow rates. When testing at the 0.2 μL/s flow rate, it is easy to see the change in the controlled pressure signal. The pressure signal is a smooth curve that is always either increasing or staying constant. When comparing the flow profile seen with the modified proportional controller to the flow profile generated before the heuristic modification, there are noticeably fewer flow rate fluctuations across the set point curve. This shows that adding in the heuristic improves the performance of the controller.

When testing was done at the 0.33 μL/s flow rate, the changes in the pressure and flow rate curve were similar to those seen with the 0.2 μL/s flow rate. The pressure signal is much smoother and continuously increasing as expected. The flow profile still contains fluctuations about the set point curve, but these fluctuations are acceptable and expected. While the modified proportional controller works well for flow rates up to 0.33 μL/s, its performance is not adequate for higher flow rates. The controller needs to be able to achieve flow rates of up to 1 μL/s, and that is not achievable with this control scheme. At this flow rate the modified proportional controller causes large spikes in flow two orders of magnitude higher than the flow rate set point. Such instantaneous flow rates are similar to the high instantaneous flow rates seen when using the standard flow control system. Too much fluid is dispensed too quickly, resulting in a period of lower flow as well. This is likely because of the large flow rate errors that occur when the controller is trying to keep up with the initial ramp up of the set point curve. This results in a high pressure jump causing a significant fraction of the pump chamber volume to be dispensed too early. Once too much fluid is dispensed, there is no way to meet the set point curve and because of the resulting increasing flow rate error, the applied pressure continues to increase until the pump cycle finishes. This is a major limitation in controller performance and shows that this controller cannot satisfy the flow rate requirements of the system.

### Changing to a New Control Approach

To determine what control method would be a better fit for the system, the unique features of the system were explored. The main features are: the necessary discontinuous operation of the controller due to valve actuation, the repetitive nature of the task, and that each dispense is repeated in a fixed time interval.

Based on the unique features of the control problem, iterative learning control (ILC) is an ideal control algorithm to use for the actuation of the micropump. ILC was developed for repetitive control tasks that occur over a fixed time interval. An accurate system model is not necessary when using ILC, which makes it ideal for complex systems. An ILC algorithm generates an open loop signal that is then modified after the control iteration is complete. Therefore, ILC is used to improve the performance of uncertain systems by using prior controller experience [Li, et al, IEEE Transactions on Automatic Control, 59(7):1954-1960 (2014). Implementing an ILC algorithm is discussed below.

### Iterative Learning Control

Iterative learning control (ILC) is a type of learning controller is based on the premise that a system's performance when executing a repeated task can be improved when prior executions of the task are used as a learning tool. This means that as a task is performed, task accuracy is iteratively improved [Bristow, et al. IEEE Control Systems Magazine, 26(3): 96-114 (June 2006). ILC generates an open-loop control signal which converges through repetition and learning. ILC is essentially a learned open-loop control strategy.

The control branch of learning controllers is utilized for systems that repeat the same operation many times without any change to the system operating conditions. For these systems, learning controllers have an edge over non-learning controllers because a non-learning controller results in the same tracking error on each path. The controller is not aware of the tracking error that is repeatedly occurring, so the controller is unable to correct itself. Implementing ILC improves performance by using the error information of previous trials to update the open-loop control signals for future iterations. Because of this, ILC algorithms can achieve high performance with low transient tracking error even if there is large model uncertainty and repeated disturbances when the task is completed.

While ILC is a type of learning controller, it is unique when compared to other learning control strategies, such as neural networks, adaptive control, and repetitive control. Using neural networks results in the modification of controller parameters (the network of neurons) rather than a control signal itself. Adaptive control is also focused on modifying the controller itself rather than the control signal. Repetitive control is quite similar to ILC, except while ILC is intended for discontinuous re-peated task operation, repetitive control is meant to be operated continuously. Therefore, ILC requires a break between iterations of a task and repetitive control is used when one iteration immediately follows the previous iteration. The initial conditions of the system using ILC control is the same for each trial. The initial conditions of a system using repetitive control are the final conditions of the previous trial. The difference in initial conditions yields different learning techniques and results [Longman, Inte. J. Control, 73(10):930-954 (2000).

Since ILC is used to improve system performance when a single operation is executed repeatedly, it has found practical success in a variety of applications, including robotics, manufacturing, and mass production assembly lines [Arimoto, et al. J. Robotic Systems, 1(2):123-140 (1984); D. Bristow and A. Alleyne, Proceed. 2003 American Control Conference 3:2620-. Kim et al” IEEE Transactions on Industry Applications, 32(1):66-72 (1996); Havlicsek and Alleyne, IEEE/ASME Trans. Mechatronics 4(3):312-323 (1999); Pandit and Buchheit, IEEE Transactions on Control Systems Technology, 7(3):382-390 (1999), Fiorentino, wr L. Key Engineering Materials, 651-653:1096-1102 (2015). Implementing an ILC algorithm is also a good way to train an open-loop controller, and is ideal for applications where an open-loop controller provides an adequate performance. An example of using this open-loop controller training technique is developing fast-indexed motion control of highly nonlinear actuators [Giessen, et al. Proc. Amer, Control Conf. 4:3788-3793 (2004)

### Why Iterative Learning Control is Ideal for Controlling Micropump Flow

The repetitive nature of the controlled portion of the pump stroke, discontinuous con-troller operation, and set timing interval of the control period make the micropump an ideal candidate for an ILC algorithm. Implementing an ILC algorithm causes the pump performance to improve over time as the system learns from the previously executed pump strokes. The flow profile smooths out over time as the accuracy of the control signal is iteratively improved. The control curve generated using ILC is an open-loop control curve. A new learned open-loop curve will be generated after each pump stroke is performed and the errors of the previous trial(s) are input into the ILC algorithm.

Implementing an ILC algorithm to control the flow profile of the micropump has the added advantage of generating signals that can then be used for open-loop control. When the ILC algorithm is run, it is acting as a training mechanism for an open-loop controller. The open-loop pressure signals derived with the ILC system will be used for an open-loop control system if the open-loop flow response is promising.

### A Modified Iterative Learning Control Approach

As was true with the controller, the manipulated variable for the ILC algorithm is kept as the change in pressure, dPᵢₙ/dt. The control signal of the ILC algorithm is dependent on how the update equation that is used. The simplest update equation for an ILC algorithm is as follows:

uⱼ₊₁(k)=uⱼ(k)+λeⱼ(k).

Here the subscripts j and k represent the iteration number of the algorithm and the time [symbol] during that iteration, respectively. In the case of the micropump application, uⱼ₊₁(k) represents dPᵢₙ/dt of the j+1 iteration of the pump stroke at time index k. uⱼ(k) is dPᵢₙ/dt of the j iteration of the pump stroke at time index k. λ is an update weight and eⱼ(k) is the flow rate error of the j iteration of the pump stroke at time index k.

This update equation is used for a first-order linear ILC algorithm of the type described in [Gunnarsson and Nonlöf, “A Short Introduction to Iterative Learning Control,” Department of Electrical Engineering, Linkoping University, Linkoping, Tech. Rep., 1997]. The order of the ILC algorithm is determined by the number of previous iterations of e are used to calculate u for the next iteration. For example, a second-order linear ILC algorithm would use this update equation with update weights λ₁ and λ₁:

uⱼ₊₁(k)=uⱼ(k)+λ₁eⱼ(k)+λ₂eⱼ₋₁(k).

The sampling rate used to get the flow rate from the Sensirion is 100 Hz. For a typical ILC algorithm, every sample in the taken during a single iteration is used to calculate the error at each sample time to update the control signal generated. This means that if 500 flow rate samples were taken, the update equation would be used for k=0, 1, 2, . . . , 499. However, because of the shape of the pressure wave signal generated using the initial proportional controller, it was hypothesized that an ILC algorithm could be used to generate a control signal formed by N lines of pressure versus time. This was hypothesized since the pressure signal should always be increasing and follows the shape of a curve made up of multiple linear segments. Generating N lines to make up the control signal means that N flow rate samples would be used in an iteration to calculate N errors to control the slope of N lines.

This is a modified approach to a traditional ILC algorithm. Only a small subset, for example, 7, of flow measurements are used for the error calculation. These errors are then plugged into the update equation. The update equation is used 7 times and the new slopes of the lines have then been calculated. These new slopes, dPᵢₙ/dt , are then be used to generate the open-loop control signal for the next pump stroke iteration. While it seems counter-intuitive to not use all the data collected to update the control signal, it is assumed that future applications would only take N samples with the sensor. In this work the 100 Hz sampling rate is being used to confirm that the flow profile achieved using the modified ILC approach is adequate.

### Controlling Change In Pressure

To keep the ILC algorithm simple, a second-order linear update equation was chosen. In comparative studies, not much difference is seen between first and second-order designs and both perform well. However, uncertainties in the plant, in this case the micropump, that may cause a difference between consecutive iterations can be smoothed over with a second-order algorithm since two iterations of the error signal are used to update the control signal Norrlöf, Proc. of the 39th IEEE Conference on Decision and Control, 2000]. Therefore, a second-order algorithm was chosen because it does not add significant complexity and has potential benefits. This update equation is used with the proposed modified ILC approach of composing the control signal from multiple linear segments. The weights and number of lines are determined through trial and error. Additionally, the LabVIEW front panel was updated to a more streamlined user interface for using the ILC algorithm. The updated front panel has three additional user inputs. The user can now select the number of points, N, used for the ILC algorithm, the type of controller that should be used (ILC, proportional controller, open loop, etc.), and the shape of the flow rate set point curve. The set point curve is classified as a ramp in set point curve. The ramp in set point curve can be divided into two parts: a ramp up from a flow rate of 0 to the flow rate that brings the integral of the flow rate set point curve to 1 μL and a constant function at the ramp's ending flow rate. The ramp portion of the curve has a period of 0.1 T. An additional set point curve option was added called the ramp in and out set point curve. The ramp in and out set point curve starts the same as the ramp in set point curve, but ends with a descending ramp from the constant flow rate to 0 μL/s over a period of 0.1 T.

The ILC algorithm to be implemented is used to generate an input pressure control signal. The signal is determined by controlling the change in pressure, dPᵢₙ/dt, which is the slope of the control signal. The modified ILC approach could be used to determine the slopes in three different ways. These three methods will be referred to as the left point slope method, the right point slope method, and the midpoint slope method. The left point slope method would use the flow rate error found at the sample time where the line starts to plug into the update equation to get the updated slope of the line. The right point slope method would use the flow rate error found at the sample time where the line ends to plug into the update equation to get the updated slope of the line. The midpoint slope method would use the flow rate error found at the sample time corresponding to the midpoint of the line to plug into the update equation to get the updated slope of the line.

To determine which slope method works the best, all three methods were experimentally implemented. Each method was implemented using an 8 line second-order linear ILC approach. The flow rate set point curve was set as a ramp in and out curve. The two weights used for the update equation were determined through trial and error until only gradual updates were made. The same weights were used for each approach. Using 8 lines for the ILC algorithm was determined to be ideal because 8 lines is the least amount of lines that offers a smooth and stable flow profile. The first iteration of the ILC algorithm uses a single line as the pressure control signal. This line is a ramp from minimum to maximum pressure. For testing which slope method works best, the ILC algorithm was run to produce a 0.5 μL/s flow rate. When the left point slope method was implemented, it quickly became apparent that this method does not result in a stable algorithm. When the midpoint slope method was implemented, instabilities also arose. The right point slope method is stable and results a smooth flow profile.

The modified ILC approach utilizing the right point slope method yielded promising initial results. However, to ensure the algorithm remained stable, the flow rate set point curve had to be set to a curve that ramps both in and out as opposed to the original set point curve that was only ramped in. This is because the fluctuations about the set point curve cause too much fluid to be dispensed before the pump stroke is finished. This results in an accumulating error over the pumping iterations at the last sampled point at time t_{f} within the pump stroke period. Because the fluid in the pump chamber is a depleting resource, if the fluid volume dispensed by time t is greater than the area under the set point curve over the interval from t0 to t, the flow rate error at time tf will be positive. This is because there is no longer enough fluid contained in the pump chamber to meet the flow rate set point without a sudden step in pressure. The positive error that occurs at t_{f} during each pump stroke causes the slope of the last line to increase without bounds until the hardware malfunctions. If a ramp out is added to the set point curve, the final value of the set point curve is 0 μL/s which can be met no matter how much volume has been depleted. Therefore, the ramp out is necessary to prevent malfunctions.

### ILC Algorithm Improvements and Results

One way to improve the ILC algorithm is to take advantage of the fixed volume of the pump chamber. Ideally, each pump stroke will dispense exactly 1 μL. By using the same volume estimation performed by the totalizer during the dispense stroke, the total fluid dispensed during that stroke can be calculated. This volume can then be converted to a flow rate by dividing the volume by the period of one pump stroke, the average flow rate of the pump stroke. The desired flow rate minus the average flow rate of the pump stroke is a flow rate error that provides an indicator of whether too much or too little fluid was dispensed during the pump stroke iteration.

To avoid using the last flow rate error from the last instantaneous flow measurement point, the average flow rate error can be used in its place. This ensures the slope of the last line will not grow unbounded even if a ramp in only flow rate set point is used. This also drives the average flow rate as close to the desired flow rate as possible. This version of the ILC algorithm is referred to as the right point slope with volume check method.

Another adjustment made to the ILC algorithm was implementing a heuristic similar to the one used for the modified proportional controller discussed in the previous chapter. Again, the change in pressure should never be negative, so all slopes should not be capable of dropping below 0. This is based on the fact that fluid should be continually dispensed from the fluid chamber and no fluid should backflow into the chamber during the dispense period.

After implementing these changes, the finalized ILC algorithm was tested at various flow rates. The three main test flow rates used were 0.5, 0.75, and 1 μL/s. Testing was also done at lower flow rates between 0.1 and 0.5 μL/s, but the main concern was hitting higher flow rates that could not be reached with the modified proportional controller. Once it was confirmed that smooth flow profiles could be easily achieved at low flow rates using the ILC algorithm, high flow rates became the focus. The testing performed at a 0.5 and 0.75 μL/s flow rate was done using an 8 line second-order linear ILC approach; however, because of the short control period when running the algorithm at a 1 μL/s flow rate, a 6 line second-order linear ILC approach was used.

The resulting pressure signal and flow rate measurements were taken when testing at the 0.5 μL/s flow rate. Aside from the spikes in the flow profile from opening and closing the outlet valve, the fluctuations about the flow rate set point curve are small and in the acceptable range. During the initial ramp up period, the measured flow rate only slightly lags behind the set point curve. The pressure signal, otherwise known as the control signal, is a smooth curve that is actually composed of 8 lines. The slopes of these lines are determined by the ILC algorithm. At the time of this data capture, the algorithm had been running for over 8 hours and the average flow rate at that time was 0.502 μL/s. This accurate average flow rate is the result of the volume check component of the algorithm.

The resulting pressure signal and flow rate measurements were made when testing at the 0.75 μL/s flow rate. When the flow rate was increased to 0.75 μL/s, the fluctuations across the flow rate set point increased. This is expected since the set point has to increase to reach the higher flow rate. The fluctuations about the flow rate set point curve are still in the acceptable range and the flow profile has been greatly smoothed when compared to the standard flow control method. During the initial ramp up period, the measured flow rate only slightly lags behind the set point curve. Similarly to the ILC algorithm run for a flow rate of 0.5 μL/s, the control signal is a smooth curve composed of 8 lines with slopes that are determined by the ILC algorithm. At the time of this data capture, the algorithm had been running for over 1 hour and the average flow rate at that time was 0.746 μL/s. This accurate average flow rate is the result of the volume check component of the algorithm.

The resulting pressure signal and flow rate measurements were made when testing at the 1 μL/s flow rate. When the flow rate was increased to 1 μL/s, the fluctuations across the flow rate set point increased as well. This is expected since the set point has to increase to reach the higher flow rate, and because the pump is being actuated at a rapid cycle rate of 1 Hz. This rapid cycle rate results in a dispense period of 740 ms, because it takes 260 ms to aspirate and actuate the valves. Dispensing over a short period of time presents two challenges: quickly achieving a high flow rate without overshooting too much and maintaining the high flow rate for the duration of the dispense. Fluctuations are expected and ensure too much fluid is not dispensed too quickly. The highest instantaneous flow rates measured were approximately 200 μL/min, which is still an order of magnitude lower than the flow spikes created with the standard flow control system. While these fluctuations are higher at the 1 μL/s flow rate, they are still in the acceptable range for this flow rate. The flow profile has thus been greatly smoothed when compared to the flow profile generated with the standard flow control method. During the initial ramp up period, the measured flow rate only slightly lags behind the set point curve. For the high flow rate of 1 μL/s, the control signal is composed of 6 lines with slopes that are determined by the ILC algorithm. At the time of this data capture, the algorithm had only been running for 5 minutes and the average flow rate at that time was 0.964 μL/s. Since the algorithm has only been run for a short period of time, the volume check component of the algorithm has not yet been able to drive the flow profile closer to 1 μL/s.

The finalized ILC algorithm produced great results when testing high flow rates. The performance is much better than what was achieved with the initial modified proportional controller. The ILC algorithm successfully generates smooth flow profiles for flow rates up to 1 μL/s. Therefore, the ILC algorithm does satisfy the flow rate requirements of the system.

### Stability

To check the stability of the ILC algorithm, the controller was run for over 24 hours. The ILC algorithm was set for controlling 8 lines using the right point slope with volume check method. This means that 7 sample points of flow and the volume dispensed were used to determine the errors used in the algorithm. The 7 sample points of flow are compared to the flow set point and used to control the slopes of the first seven lines. The volume dispensed is used to calculate the average flow rate for that dispense cycle. The error between the average flow rate and the commanded flow rate is used to determine the slope of the last line. This volume check method is essential to ensuring the stability of the ILC algorithm.

For the stability test, the desired flow rate was set to 0.5 μL/s, since this is a flow rate that will be commonly used for biological experiments. The ILC algorithm maintained a stable smooth flow profile after running for 24 hours. The fluctuations about the flow rate set point curve stayed at a small acceptable level. The control signal remained as a smooth pressure wave experiencing only small changes with each iteration. The average flow rate after running for this long was approximately 0.502 μL/s, showing that the volume check component of the algorithm does cause the flow profile to converge to the desired flow rate over time. These results show that the analyzed ILC algorithm is stable.

### Using Iterative Leaning Control to Develop an Open-Loop Controller

ILC can also be used as a training tool for developing an open-loop controller. In order take advantage of the open-loop controller capabilities of ILC, the ILC algorithm was run at 0.25, 0.5, 0.75, and 1 μL/s for the purpose of generating open-loop curve parameters. The ILC algorithm was run for an adequate amount of time so convergence to a representative control signal could take place. Once the control signal and flow profile were converged, the open-loop parameters were captured. In this case, open-loop parameters refers to the array of slopes for the lines that make up the control signal pressure wave.

Once the open-loop parameters were collected for flow rates of 0.25, 0.5, 0.75, and 1 μL/s, these parameters were used to run the pumps in an open-loop configuration. For both open-loop controllers, the flow profile and pressure signal stay consistent across multiple pump stroke iterations. These results show that using an open-loop controller to run the pumps can result in the desired smooth flow profile. This is a good option, as no feedback is active and simpler and safer operation results.

### Flow Control Using Optical Sensor Feedback

To eliminate the need for a sensor, such as the Sensirion, directly interacting with the microfluidic chips, indirect sensing methods were explored. Since these chips are designed to be single use and disposable, it is advantageous to integrate any sensing elements used for feedback control into the chip platform manifold itself. Currently, the manifolds are designed to hold four chips and the design could be easily changed to contain sensing elements for these chips; that way the sensors are part of the manifold and not part of the chips. The integrated sensors could then be used for feedback control purposes and/or as an alert system for when a chip's micropump is malfunctioning.

Currently, the pneumatic manifold that houses the chips is designed to send the same pneumatic signals to the four chips secured within the platform. In the future, it is likely that multiple platforms would be controlled by the same pneumatic control unit. This would allow for dozens of chips to be run simultaneously in the same way for large batch experiments. Since the chips would not be controlled individually, a closed-loop control system would likely need to rely on the feedback from a “master” chip or some average over all the chips. In this scheme, each chip can be monitored to detect chip malfunctions, such as leaks, delaminations, and membrane tears.

Using the pressure signals discovered when developing the feedback-driven flow controller as an open-loop control system is a promising endeavor. With this in mind, it could make sense to rely on an open-loop control scheme and solely use the feedback provided through indirect sensing to alert the user if a chip's pump is malfunctioning so they can account for the malfunction when analyzing the results of the biological experiment they are running on the platforms.

### Selecting an Indirect Sensing Method

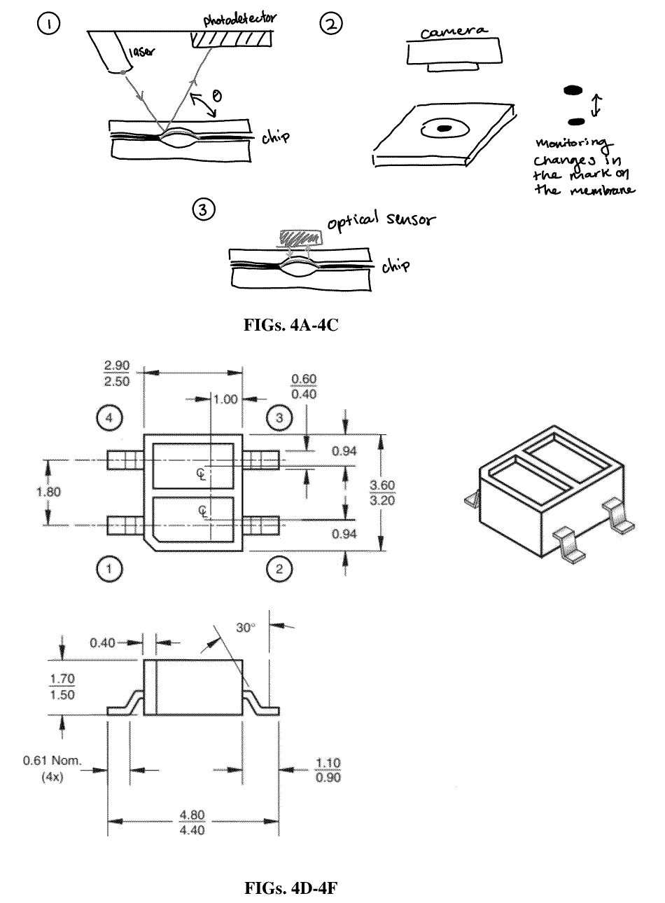

Different indirect sensing methods focused on detecting pump displacement were considered in an attempt to move away from direct flow sensing. The three main proposed sensing methods included shining a laser at the pump chamber membrane coated in reflective material, using a camera to estimate displacement, and using an optical sensor to detect pump chamber movement. The first requires a laser, photodetector and reflective coating. The laser would be pointed at the membrane and the angle the laser reflected at would be dependent on pump chamber displacement. This angle would be determined using a photodetector. The second method would require a camera and a mark on the pump chamber membrane. The position of the mark would be tracked using the camera and changes to the shape would be used to determine the current displacement of the pump chamber. The third method would require an optical sensor package and a pump chamber coating compatible with the sensor being used. Illustrations of the three proposed method can be seen in FIGS. 4A-4C.

The simplest and cheapest option is using an optical reflectance sensor to detect pump chamber displacement. The optical sensor that has been used by other members of the Precision Motion Control Lab is the QRE1113 miniature reflective object sensor [Weinreb, “A novel magnetically levitated interior permanent magnet slice motor,” Thesis, Massachusetts Institute of Technology, 2020, accepted: 2021 March-22T17:31:05Z; Hamer, et al. “A Magnetically Suspended, Spherical Permanent Magnetic Dipole Actuator,” MIT web domain, 2018, accepted: 2021 November-05T15:05:24Z; M. Noh, “Homopolar bearingless slice motors with magnet-free rotors for extracorporeal life support,” Thesis, Massachusetts Institute of Technology, 2018, accepted: 2019 February-05T16:01:50Z; L. Zhou, “Magnetically levitated hysteresis motor driven linear stage for in-vacuum transportation tasks,” Thesis, Massachusetts Institute of Technology, 2019, accepted: 2019 September-16T21:16:31Z]. The QRE1113 costs approximately one dollar and is quite compact. The largest profile of the sensor measures less than five millimeters, FIGS. 4D-4F. The sensor package contains both an infrared (IR) light emitting diode (LED) and a phototransistor, FIGS. 4D-4F. The QRE1113 can be used to monitor displacement because the phototransistor collector-emitter current is dependent on the amount of IR light reflected back onto the phototransistor from the surface illuminated by the LED.

### Coating the Membranes

In order to detect the displacement of the membrane of the pump chamber, the transparent COC membrane needs a coating of some sort. The optical sensor emits infrared light, so the coating must be able to reflect infrared light. Furthermore, to ensure that there is no biological contamination from the coating, the membrane should be coated on the pneumatic side and not the fluidic side. This ensures that the fluidic circuit is not contaminated. Furthermore, coating the pneumatic side eliminates the possibility of the coating being broken down by the cell media.

### Toner Transfer Foil

Toner transfer foil, which is typically used in arts and crafts projects, is a thin film that can be transferred onto dry laser printer toner using heat. This allows transferring to a printed pattern or some substrate. Toner transfer foil comes in a variety of colors, but most of the foils are shiny and metallic-colored. The foil is used to print the desired design using a laser printer so the design can then be covered in the foil. After printing the design, the foil is placed on top and then heated. Heating the foil causes it to adhere to the toner. The sheet is then peeled off and only the foiled design remains.

Initial testing was performed to see if the toner transfer foil could be properly transferred onto the E-140 membrane material. At first, a mask was printed using a laser printer to allow for the transfer of the foil onto all the printed areas. Transferring the foil onto the toner mask worked most of the time, but often some foil patches were left behind. To avoid this, a document laminator sheet was used as the mask. To make the masks, one half of a laminator sheet was cut using a vinyl cutter. The shape of the membrane was cut with a hole cut out where the pump chamber membrane is. The adhesive material contained in the document laminator sheet melts and sticks to the toner transfer foil when heated. When the document laminator sheet mask is peeled off, all that remains is the template to be aligned with the membrane for transfer of the pump chamber coating.

The finalized transfer process is a six step process. Step one: vinyl cutting the document laminator sheet to the correct mask shape. Step two: cut a rectangular portion of the transfer foil and stack this on top of the document laminator sheet. Step three: Place the stack between a folded piece of paper and send this through a laminator approximately five times. Step four: peel the laminator sheet mask off the transfer foil rectangle, the template for transferring the pump chamber coating on the membrane should remain. Step five: align the template outline with the outer edge of the membrane and then send these through the laminator approximately three times. Step six: peel the transfer foil rectangle off the membrane, and the circle pump chamber coating will remain on the membrane.

### Verifying the Ability to Sense Pump Displacement

After dialing in the process of coating the membrane, it was time to laminate the membrane to the pneumatic side of a chip for testing. The first round of testing was done by securing the coated pneumatic side of the chip in a vice while holding the optical sensor a few millimeters away from the chip with a helping hand. Once both the pneumatic side and optical sensor were positioned properly, a pneumatic line connected to a pressure regulator outputting approximately +8 psi was used to actuate the pump chamber. The voltage measurement from the optical sensor was monitored using the myRio analog input. The quick change from no applied pressure to +8 psi being applied caused a step response in the optical voltage reading. Once the pneumatic line was removed the optical reading returned back to its original voltage reading.

### Assembling Toner Transfer Foil Coated Chips

After verifying that the toner transfer foil coating yielded promising results, two different types of toner transfer foil were tested. Because the transfer foil is transferred to the membrane such that it comes into contact with only the pneumatic side of the chip, only the backside color of the transfer foil is important. The two transfer foils that were tested have a shiny silver-colored surface and a nearly matte white colored surface. The shiny transfer foil offers an optically specular surface while the white transfer foil acts as a more optically diffuse surface.

Both transfer foils were applied to two different pump chips to have two bonded chips for testing. The process described above was used to coat the pump chamber membrane with 3 mm diameter circles of the transfer foil. A circle diameter of 3 mm was selected since that is the diameter of the pump chamber. After the membranes were coated, the chips were assembled used a laminator and heat press using the process in D. A. O'Boyle, “Integrated Disposable Microfluidic Tissue Chips,” Thesis, Massachusetts Institute of Technology, June 2021, accepted: 2022 January-14T15:06:43Z. These two chips were used to collect the optical data discussed in the remaining sections of this chapter.

### Optical Data From Open-Loop Control

The LabVIEW front panel was updated to have a graph for monitoring the optical sensor output. By updating the LabVIEW code and assembling chips with the proper pump chamber coating, it became possible to see what the optical sensor reading looks like when the pump is actuated using the open-loop controller. By monitoring the optical sensor voltage output while running the open-loop controller, one can verify the optical sensor's potential as an indirect sensor for a modified ILC algorithm. If the optical sensor output is consistent when the open-loop controller is run, the signal can be used as the set point for a new ILC algorithm relying on optical sensor feedback.

In order to get valuable data from the coated chips, two intermediate steps needed to be performed. Since the chips that were coated do not have a way to interface to the Sensirion flow sensor, the coated chips needed to be linked to the integrated tubing connection chip. Next, the optical sensor needed to be properly secured to the chip so the sensor could produce accurate measurements.

### Finalizing an Optical Sensing Platform and Securing the Optical Sensor

A single manifold could not be used to house the two different types of chips. This is due to the fact that the integrated tubing chip and the coating chips use different pneumatic ports to control the pumps. To properly link the manifold containing the integrated tubing connection chip to the manifold containing the coated chips, the pneumatic line from the electronic pressure regulator output was split. Since the coated chips did not need to actually pump fluid, only the pneumatic line controlling the pressure on the pump chamber was necessary. By linking the two manifolds it is now possible to collect both optical and flow sensor data simultaneously.

An optical sensor holder was designed to mount the optical sensor in the correct location on the coated chips,. The optical sensor holder was designed such that the optical sensor face would be located 0.6 mm above the surface of the chip. This ensures that the pump chamber membrane remains at a distance between approximately 1.4 mm and 1.8 mm depending on the membrane position. This distance was chosen to ensure the distance from the sensor was within the ideal distance range of 1 mm to 2 mm based on the QRE1113 data sheet [Fairchild Semiconductor, “QRE1113, QRE1113GR Minature Reflective Object Sensor,” QRE1113 Datasheet, 2009; ON Semiconductor, “QRE1113, QRE1113GR, QRE1114GR Minature Reflective Object Sensor,” QRE1113 Datasheet, 2020]. The sensor holder was also designed to keep the sensor centered over the pump chamber. To make aligning the sensor holder with the chip in the manifold as easy as possible, the sensor holder is the same width as the chip and aligns with the face of the manifold.

### Shiny Silver-Colored Transfer Foil Coating Results

The chip coated with the shiny silver-colored transfer foil was the first chip the optical sensor was mounted on. Once the optical sensor was set up properly, the open-loop controller was run at a flow rate of 0.5 μL/s. A flow rate of 0.5 μL/s was selected since this is a flow rate that is commonly used in biological experiments.

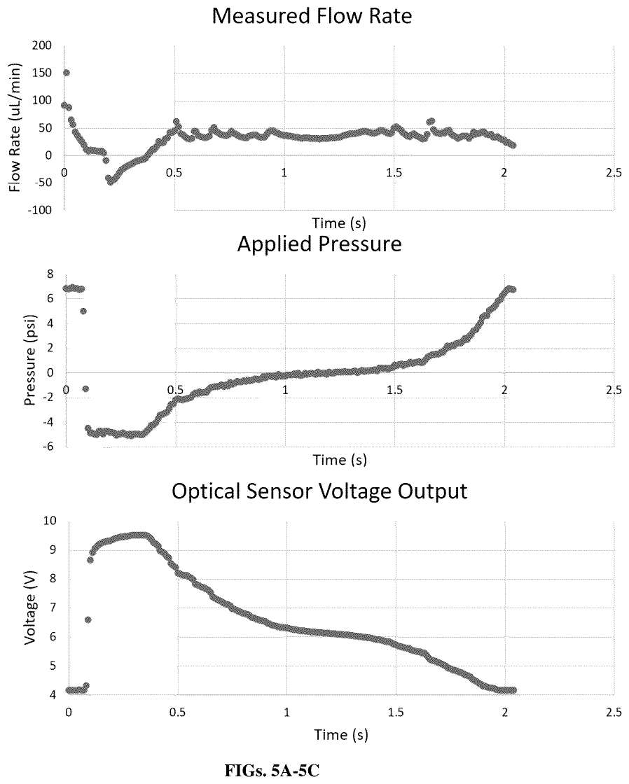

The measured flow rate, applied pressure, and optical sensor voltage output data for one pump stroke is in FIGS. 5A-5C. The flow, pressure, and optical data was obtained from a single pump stroke of the chip coated with the shiny silver-colored transfer foil. The pump stroke is being performed at a flow rate of 0.5 μL/s. At time 0, the outlet valve is being closed, so the first small portion of the plots is occurring when the outlet valve is closed and then subsequently opened. After the valve is opened, the dispense sequence occurs. The flow and pressure data look as expected when running the pumps with the open-loop controller. The optical sensor output voltage starts at a high voltage when dispensing begins, and then follows a smooth curve to a low voltage once dispensing is complete. The total voltage drop is on the order of 5 V. The first section of data points on all the graphs is showing the outlet valve closing and opening and is not part of the controlled dispense state portion of the pump stroke. The applied pressure wave is consistent with the pressure command being used to control the electronic pressure regulator. The measured flow rate data is consistent with the response seen using the open-loop controller at a flow rate of 0.5 μL/s, which shows that the pump is functioning properly.

Once the applied pressure is being changed gradually during the dispense state of the pump stroke, the pump chamber membrane begins to smoothly displace. As the pump chamber membrane displaces under the applied pressure, the optical sensor voltage output goes from a high voltage to a low voltage. The highest voltage reading is occurring when the pump chamber membrane is fully pushed down into the pocket on the bottom pneumatic side of the chip. The lowest voltage reading corresponds to the pump chamber membrane being fully pushed up into the pocket on the top fluidic side of the chip. The optical sensor output during the dispense state is a smooth curve that could be used as a set point for a new ILC algorithm.

To ensure there are no fluctuations of the optical voltage output across individual pump strokes, the optical data of three different pump strokes was collected and plotted on the same graph. The resulting overlay plot is in FIG. 6-15. The data from the three pump strokes is nearly identical. Because the data from the three pump strokes is nearly identical, this curve can be used as a set point curve for an ILC algorithm based on optical sensor feedback without any issue.

### Matte White Transfer Foil Coating Results

To keep the testing parameters consistent across the two coated chips, the open-loop controller was kept at a flow rate of 0.5 μL/s. The optical sensor holder was removed from the chip coated with the shiny silver-colored transfer foil and mounted onto the chip coated with the matte white transfer foil instead. Similarly to the data collected from the shiny silver-colored coated chip (FIGS. 5A-5C), the first section of data points on all the graphs shows the outlet valve closing and opening and is not part of the controlled dispense state portion of the pump stroke. Both the measured flow rate data and applied pressure wave are consistent with the response seen using the open-loop controller at a flow rate of 0.5 μL/s, which shows that the pump is functioning properly.

When looking at the collected optical sensor voltage output data, the shape and voltage drop magnitude of the curve is different than what was seen using the shiny silver-colored coated chip. The voltage drop is an order of magnitude less (500 mV vs 5 V), but this can be rectified by modifying the optical sensor circuit to increase the brightness of the LED or by changing the phototransistor collector resistor value. The shape of the optical voltage curve is not a continuous gradual voltage decrease, which was seen on the other chip, and is instead a steep voltage drop off followed by a slow voltage drop off until dispensing is complete. Just like with the shiny silver-colored coated chip, the highest voltage reading occurs when the pump chamber membrane is fully pushed down into the pocket on the bottom pneumatic side of the chip. The lowest voltage reading corresponds to the pump chamber membrane being fully pushed up into the pocket on the top fluidic side of the chip. While the shape of the optical sensor curve is different, it is still a continuous, smooth curve that could be used as a set point for a new ILC algorithm.

Again the optical data of three different pump strokes was collected and plotted on the same graph to ensure there are no fluctuations of the optical voltage output across individual pump strokes. The data from the three pump strokes in nearly identical and the individual curves cannot be seen on the plot because of this similarity. Since the data from the three pump strokes remains nearly identical, this curve could also be used as a set point curve for an ILC algorithm based on optical sensor feedback, but it should only be used with matte white coated chips.

### Using Optical Feedback

Since it had been established that optical sensor feedback could be used for a new ILC algorithm, a new algorithm was established. For simplicity, it was decided that the flow rate feedback ILC algorithm would be modified to be used with optical sensor feedback instead. To properly modify the algorithm the relationships between pressure, displacement, change in pressure, and flow rate need to be revisited.

The initial ILC algorithm generates N slopes to construct an open-loop curve. The slopes correlate to the change in pressure, dPᵢₙ/dt, which is proportional to flow rate,

$$Q = \frac{dV}{dt} .$$

Controlling slopes is the correct choice for the original algorithm since the flow rate is proportional to the change in pressure. However, since optical sensor feedback correlates to displacement, x, and not to flow rate, dPᵢₙ/dt, modifying the slopes of the lines no longer makes sense. Instead, the starting point of each of the lines should be controlled. This will then correlate to pressure itself rather than change in pressure. Since displacement is proportional to pressure, controlling the starting points of the lines is the correct approach for the new ILC algorithm. The optical ILC algorithm has the same structure as the flow rate ILC algorithm:

uⱼ₊₁(k)=uⱼ(k)+λ₁eⱼ(k)+λ₂eⱼ₋₁(k)

The manipulated variable, uⱼ(k), now corresponds to Pᵢₙ rather than dPᵢₙ/dt. The error in the equation, eⱼ(k), now corresponds to optical error between the optical sensor measurement and the optical set point curve. The update weights, λ1 and λ2, were adjusted using trial and error to determine the ideal numerical values. Each time the algorithm was run, the weights were initially changed by an order of magnitude until the performance started to stabilize. Next, small adjustments were made until changes in performance were not apparent. The shiny silver-coated chip is used when running the optical ILC algorithm. The set point curve is estimated as four lines based on the optical data collected from the shiny silver-coated chip when running the open loop signal for a flow rate of 0.5 μL/s. The slopes and period of these four lines were determined by sectioning the data and estimating the line of best fit for each 10 section. Just like with the original ILC algorithm, the starting pressure wave is a straight line ramping between minimum and maximum pressure.

The optical ILC algorithm is run at 0.5 μL/s as a ten point algorithm. This means ten equally spaced optical measurements are used to calculate the optical error at these points. These errors are then fed into the algorithm to adjust the output pressures at these points. The pressure input is then extrapolated by connecting these ten points with lines. After running for two minutes, the optical sensor data matches the set point.

After running for two minutes, the average flow rate is 0.55 μL/s. The flow rate is slightly higher than the input flow rate because the pump chamber volume is slightly higher than 1 μL and is fully depleted during the initial stages of the algorithm when a pressure ramp is being applied. The flow profile is not exactly the same as what is produced running the open-loop controller since the optical set point curve is estimated as four lines. The performance could be improved further by tuning the optical set point curve.

This is a very promising outcome of using optical feedback to control the flow rate of the micropump. More work should be done to optimize the pump chamber coating and the corresponding set point curve. These results prove that the optical sensor is a viable indirect sensing method that can be used to generate smooth flow on the chips using the ILC algorithm.

### Open-Loop Flow Control Unit and App

Based on the promising flow profiles generated by the open-loop pressure signals derived with the ILC system, it was determined that building an open-loop control unit was a worthwhile endeavor. The open-loop flow controller will be used instead of the two-part CNBio pump control units. The control unit needs to be compact, easy to use, and work for multiple flow rates. To ensure the control unit can be used for experiments, it will be run continuously for multiple days.

### Designing the Control Board

To control the micropump properly, the control board needs to contain much of the same hardware as described above. However, since no closed-loop control is being done with the platform, robust real-time NI hardware, like the myRIO, is not necessary. To control the solenoids and electronic pressure regulator digital and analog output capabilities are needed. Additionally, the control board does not include pressure regulators to provide inputs to the back pressure regulators on the chip.

### Compact Design

To keep the design of the control board compact, various changes were made to the electrical and pneumatic components that were originally used in the bench-top setup. Three main pneumatic component changes were made to both organize the board and make the system more compact. Smaller footprint pressure regulators were selected, a manifold was added, and the tubing used for positive and negative air pressure was color coordinated; blue tubing was used for negative air pressure, while red tubing was used for positive air pressure. The incorporated manifold is a dual-section right-angle flow manifold that has three outputs for both positive and negative air pressure signals. The electrical hardware changes were focused on replacing a breadboard with something more permanent and switching out the myRIO. Instead of a standard breadboard, a small solderable breadboard was used to build the necessary electrical circuits. The myRIO utilized in the bench-top setup was deemed unnecessary. The myRIO was replaced with Tinkerforge components, which are compact, stackable microcontroller building blocks [Doc|Tinkerforge|Getting Started|Primer.” https://www.tinkerforge.com/en/doc/Primer.html#primer].

### Tinkerforge Hardware

The Tinkerforge building block system lends itself to the creation of tailored, modular electrical platforms. Tinkerforge hardware is categorized into Bricks and Bricklets. Each system needs at least one Brick, since the Brick is the base module that acts as a connection point for Bricklets. A Bricklet is a sensor/actuator module that connects to a Brick with a cable [Doc|Tinkerforge|Getting Started|Primer.” https://www.tinkerforge.com/en/doc/Primer.html#primer. The easy cable connection makes adding or removing Bricklets to a system a quick task. Another benefit of Tinkerforge hardware is the fact that many programming languages are supported.

For the open-loop control board, three Tinkerforge modules were used: a Master Brick (2.0), an Industrial Analog Out Bricklet (2.0), and an IO-16 Bricklet (2.0). The three modules can be seen in FIG. 7-2. These components are controlled using a Python program to run the pumps.

### Finalized Control Board

The control board is mounted on the side of the incubator, so it was decided that a 12″×12″ acrylic sheet would act as the bounding box of the control board. Initial attempts of fitting all the components onto the acrylic sheet revealed that certain components needed to be downsized. The smallest readily available solenoid array and two compact pressure regulators were used on the board to free up space. Opting for these components kept the board neat and compact and allowed for a potential increase in functionality; by freeing up space, a section of the board was fitted with mounting holes for two Clippard Cordis unit that could be used to control the on-chip pressure regulators. Using electronic regulators with integrated sensors and control algorithms allows for a more accurate pressure drop across the gel channels.

After minimizing component footprints, the final control board layout was chosen to ensure all the electrical components were above the pneumatic components of the board to avoid potential damage to the electronics. The list of components and respective quantities used for the control board is in Table 2. Electrical wire, electrical components for solenoid circuit pneumatic tubing are also necessary, but not included in the Table.

TABLE 2
The name and quantity of all the control board components.

| Component Name | Quantity |
|---|---|
| Pressure Regulator | 2 |
| Vacuum Regulator | 1 |
| Enfield Electronic Regulator | 1 |
| Pneumatic Manifold | 1 |
| Tinkerforge Master Brick | 1 |
| Tinkerforge IO-16 Bricklet | 1 |
| Tinkerforge Industrial Analog Out Bricklet | 1 |
| Solder Board | 1 |
| Solenoids | 9 |
| Solenoid Mounting Block | 1 |
| Cordis Unit | 2 |
| 12 V Power Supply | 1 |

Clippard Cordis units are listed, but only necessary if electronic pressure regulator level control is desired for the on-chip regulators.

### Creating an App in Python

Running an open-loop control scheme eliminates the need for the robust real-time closed-loop control capabilities of LabVIEW. To make things easier for the user, Python was chosen as the programming language to use for the controller app. The Python app can be run and edited on any computer with Python installed, or run using an executable file on a computer that does not have Python.

The open-loop control app can be broken down into two main classes: the pump object, and the graphical user interface (GUI). The pump object utilizes the states of the pump to perform a pump stroke. The GUI relies on tkinter [“tkinter—Python interface to Tcl/Tk—Python 3.10.4 documentation.” [Online]. Available: https://docs.python.org/3/library/tkinter.html] and the extension ttkbootstrap [ttkbootstrap-ttkbootstrap.” [https://ttkbootstrap.5 readthedocs.io/en/latest/]. Integrating the pump object with the GUI results in an easy to use app that is both sleek and practical.

### Pump Object

The pump object class takes the state transitions and assigns them with actions to be performed by the Tinkerforge hardware. The four transitions associated with the valves, opening and closing the inlet and outlet valves, call the set output value function of the IO-16 Bricklet to switch the digital output corresponding to the valve between true (close) and false (open).

The last two transition states, aspirate and dispense, are both associated with controlling the pressure on the pump chamber. For aspiration, the voltage of the Industrial Analog Output Bricklet is set to the voltage associated with the minimum pressure applied to the pump chamber (−5.5 psi). Since aspiration is rapid, only one voltage is used; however, this is not the case for the gradual dispense of the pump chamber. The dispense state instead cycles through an array of voltages that corresponds to the open-loop pressure signal.

### Open-Loop Parameters

The open-loop pressure signals used to control the pump chamber were determined using the ILC controller. The ILC controller typically generates 8 lines (more or less lines will be used depending on the desired flow rate) that make up the pressure signal. The controller algorithm adjusts the slopes of these lines, so the pressure signal is described by an array of slopes. The start point of the first line is determined by the minimum pressure input.

For the purpose of this open-loop control board, the user can select one of four different flow rates. To provide these options, the open-loop parameters for the different flow rates is contained in the code as a dictionary containing the array of slopes for each signal. A function is then used when the pump is initialized to turn the slope array into an array of voltages. This eliminates the need for a database containing arrays of hundreds of voltage data points. Using the slopes as a way to store the information also makes it easier to modify the open-loop parameters when necessary.

### App User Interface

The app graphical user interface (GUI) was designed for ease of use and a sleek appearance. To achieve this the tkinter package, which is Python's standard interface for the Tk GUI toolkit, and the ttkbootstrap extension [ttkbootstrap-ttkbootstrap.” [https://ttkbootstrap.readthedocs.io/en/latest/], a theme ex-tension for tkinter, were utilized. The app user interface should be split into subsections based on function. Platform A section could be split into multiple sections to include the ability to run more platforms at once. Since only one open-loop control platform currently exits, this section was kept for just Platform A.

### Testing the Platform

To ensure the open-loop flow control unit and app were ready for use in long-running experiments, the app was run while connected to the control unit for over three days. In the first attempt to run the unit overnight, the laptop went into sleep mode and the program ceased to run. To avoid this, the laptop used to run the program needs to be set to not fall asleep when plugged in. Another issue that we ran into was oscillations with the Enfield regulator. When the oscillations occurred the Enfield would vibrate while making a ringing sound. The ringing would occur at random intervals and was not consistent. After troubleshooting, the root cause was discovered: variations in house vacuum supply. To ensure that this does not happen it is crucial to set the vacuum regulator between −7 and −8 psi. By keeping the set pressure in this range, the fluctuations in house vacuum are not seen downstream. After fixing these two issues, the control unit was able to run without malfunctioning for the three day period and was approved for use in future experiments.

### Summary

Multiple variations of a flow control system for smooth flow using micropumps. The three flow control system for smooth flow that were developed achieved smooth flow profiles at flow rates up to 1 μL/s. This satisfies the biological requirement that was set as a specification for this work. Two different iterative learning control (ILC) algorithms were developed to allow for feedback driven control. The first ILC algorithm relies on feedback from a flow sensor, and the second ILC algorithm uses feedback from an optical sensor. To achieve indirect sensing using an optical sensor, a way to coat pump chambers on the membrane of the chips was developed. The optical sensor can be used to eliminate the need for a sensor directly interacting with the microfluidic chips. The optical sensors can be integrated into the chip manifold directly, which keeps the chip as single use, disposable components. Integrated optical sensors can be used for feedback control purposes and/or as an alert system for when a chip's micropump is malfunctioning.

By running the flow sensor ILC algorithm at a variety of flow rates, open-loop curves for those flow rates were found. These open-loop curves are the pressure signals discovered when running the feedback-driven flow controller. The open-loop pressure signals are used in the open-loop control platform we developed. The open-loop control platform consists of both a control board and Python application. The open-loop platform will be used in future biological experiments. The open-loop platform is a vast improvement over the standard flow control system when it comes to producing a smooth flow profile.

The open-loop control platform is readily available for use. The ILC algorithm cannot currently be used until it is the standard for chips pump chambers to be coated. If more development time is put into properly packaging the electrical and pneumatic hardware needed to run the ILC algorithm, it could be packaged in a similar manner as the open-loop control platform.

The developed ILC algorithms for smooth flow control set a foundation for a feedback control system where the user can input the desired pulsatility of flow. Since a smooth flow profile has now been achieved, it is possible to add in delays to make flow profile as pulsatile as desired. The flow could be based on the biological experiment being performed, which would help ensure the experiment is run to best mimic in vivo conditions. To minimize the effect of opening and closing the outlet valve, a capacitor should be added back into the fluid circuit. The capacitor would help diminish the flow pulses made by the valves as well as the small fluctuations generated when using the flow control system developed in this work. Reintroducing a fluid capacitor would help ensure the on-chip flow profile is as smooth as possible.

To achieve even higher flow rates with the developed flow control systems, larger volume micropumps can be used. By increasing the volume of the micropump, more fluid would be dispensed in a single pump stroke, meaning that the pump chamber could be actuated over a longer period of time. Currently, actuating the micropump over too short a period of time results in large fluctuations in instantaneous flow rate. To avoid these fluctuations, the pump chamber needs to be actuated over a longer period of time. The only way to extend the period of time during which the pump chamber is actuated is by increasing the micropump chamber volume.

In summary, the three flow control systems described herein were created to generate smooth flow using on-chip pneumatic micropumps. The three flow control systems generate a significantly smoother flow profile that has acceptable fluctuations. These systems all perform consistently and provide accurate flow rates up to 1 μL/s. The three flow control system for smooth flow that were developed in this work achieved smooth flow profiles at flow rates up to 1 μL/s. This satisfies the biological requirement that was set as a specification for this work. Two different iterative learning control (ILC) algorithms were developed to allow for feedback driven control. The first ILC algorithm relies on feedback from a flow sensor, and the second ILC algorithm uses feedback from an optical sensor. To achieve indirect sensing using an optical sensor, we developed a way to coat pump chambers on the membrane of the chips. The optical sensor can be used to eliminate the need for a sensor directly interacting with the microfluidic chips. The optical sensors can be integrated into the chip manifold directly, which keeps the chip as single use, disposable components.

By running the flow sensor ILC algorithm at a variety of flow rates, open-loop curves for those flow rates were found. These open-loop curves are the pressure signals discovered when running the feedback-driven flow controller. The open-loop pressure signals are used in the open-loop control platform we developed. The open-loop control platform consists of both a control board and Python application. The open-loop platform will be used in future biological experiments. The open-loop platform is a vast improvement over the standard flow control system when it comes to producing a smooth flow profile.

The open-loop control platform is readily available for use. The ILC algorithm cannot currently be used until it is the standard for chips pump chambers to be coated. If more development time is put into properly packaging the electrical and pneumatic hardware needed to run the ILC algorithm, it could be packaged in a similar manner as the open-loop control platform.

The developed ILC algorithms for smooth flow control set a foundation for developing a feedback control system where the user can input the desired pulsatility of flow. Since a smooth flow profile has now been achieved, it is possible to add in delays to make flow profile as pulsatile as desired. With this development, the biologist could tailor the flow based on the biological experiment being performed, which would help ensure the experiment is run to best mimic in vivo conditions.

We claim:

1. A continuous flow micropump system actuated by pneumatic pressure, the system comprising
an electronically variable pressure regulator to allow for a controllable pressure signal on the pump chamber diaphragm.

2. The micropump system of claim 1 comprising a current or voltage input that is the set point for proportional pressure output of the micropump.

3. The micropump system of claim 1 comprising an electronic pressure regulator relying on the feedback provided by a pressure sensor monitoring the regulator's output pneumatic pressure.

4. The micropump system of claim 3 wherein the electronic pressure regulator has an internal PID controller that utilizes output pneumatic pressure feedback to provide a precise output pressure by continuously adjusting internal valve positions.

5. A sensor for a flow micropump comprising a membrane actuated with pneumatic pressure, the sensor comprising a reflective coating or film on the micropump, wherein movement of the coating or film is detected by measuring changes in angle or strength of a light applied to the coating or film.

6. The sensor of claim 5 wherein the sensor is used to directly measure the flow rate of the fluid exiting the outlet of the micropump.

7. The sensor of claim 5 further comprising electrical connections to the micropump controller to adjust the flow rate of the micropump.

8. The sensor of claim 5 wherein the sensor comprises a light source, the reflective coating or film, and a light receiver or photodetector.

9. The sensor of claim 8 wherein the reflective coating is an adhesive reflective film applied to the surface of the flow chamber of the micropump.

10. The sensor of claim 5 comprising an optical sensor monitoring the displacement of membrane.

11. The sensor of claim 10 comprising both an infrared (IR) light emitting diode (LED) and a phototransistor, wherein the phototransistor collector-emitter current is dependent on the amount of IR light reflected back onto the phototransistor from the surface illuminated by the LED.

12. The sensor of claim 5 wherein the sensor measures the flow the outlet valve and the back pressure regulator on the micropump.
